(19) United States
(12) Patent Application Publication
(10) Pub. No.: US 2016/0335607 A1
(43) Pub. Date: Nov. 17, 2016

(54) MANAGING AUTHORIZATION AND DEVICE CONFIGURATION FOR USE OF QUALIFIED TRANSPORTATION VOUCHERS

(71) Applicants: Robin KALLAS, Bainbridge Island, WA (US); Alexander KALLAS, Bainbridge Island, WA (US)

(72) Inventors: Robin KALLAS, Bainbridge Island, WA (US); Alexander KALLAS, Bainbridge Island, WA (US)

(21) Appl. No.: 14/711,549

(22) Filed: May 13, 2015

(51) Int. Cl. G06Q 20/04; G06Q 50/14; G06Q 20/10; G06Q 30/06; G06Q 20/40

(52) U.S. Cl. CPC G06Q 20/0457; G06Q 30/0609; G06Q 20/401; G06Q 20/102; G06Q 50/14

(57) ABSTRACT

Systems and methods are provided for managing authorization and device configuration to facilitate the usage and transfer of qualified travel vouchers in various manners that enable one or more authorized users to travel using various transportation systems and providers.

### TECHNICAL FIELD

The following disclosure relates generally to transportation systems, and more particularly to automated techniques for managing the authorization, authentication, and transfer between users of transportation vouchers or travel vouchers associated with various transportation systems.

### BACKGROUND

Travel vouchers are generally intended to simplify the process of personal transportation, such as by removing the need to purchase a distinct and separate ticket for every trip taken using a particular transportation provider or providers, or to lessen the cost of repeated such trips for travelers that regularly utilize a particular transportation provider or providers. Typically, however, travel vouchers are limited in duration or use—i.e., they have expiration dates or a specified quantity of uses for which the voucher is available for use by the original purchaser. If the travel voucher expires prior to the purchaser having used all of the associated quantity of uses, such uses are void, and typically the original purchaser of the voucher may be unable to recover costs associated with those remaining uses. Similar problems arise in scenarios in which a travel voucher does not expire, but in which the original purchaser determines that she cannot or does not wish to utilize the remaining uses associated with the travel voucher.

### BRIEF DESCRIPTION OF THE DRAWINGS

FIG. 1 is a schematic diagram of a networked environment that includes a Travel Voucher Authorization Management (“TVAM”) System as well as various computing systems associated with one or more travel voucher service providers, with one or more transportation providers, with one or more users of the TVAM System, and with one or more users of the TVAM System.

FIG. 2 is a block diagram illustrating component-level functionality provided by a plurality of electronic circuits that, when in combined operation, are suitable for performing and configured to perform at least some of the techniques described in the present disclosure.

FIGS. 3A-3C are block diagrams illustrating an overview of operations according to an implementation of a TVAM System in accordance with at least some techniques described in the present disclosure.

### BRIEF SUMMARY

Systems and methods are provided for managing authorization and device configuration to facilitate the usage and transfer of qualified travel vouchers that enable travel using various transportation systems and providers, such as, for example, ferry systems and ferry system providers. By providing information regarding a travel voucher that is selected based on specified criteria to the client device of a user not previously associated with that travel voucher, the techniques disclosed herein may facilitate that user's travel via a travel voucher that would otherwise be less than fully utilized. Similarly, by receiving and storing information regarding travel vouchers from the client device of a user associated with the travel voucher, such as in exchange for providing fees to that user, the techniques disclosed herein may facilitate the recovery of costs associated with the original acquisition of the travel voucher by that user.

Some or all of the techniques described herein may be performed by automated operations of an implementation of a Travel Voucher Authorization Management (“TVAM”) System, such as via a Web site or other site of the TVAM System, as discussed in greater detail below.

### DETAILED DESCRIPTION

In the following description, certain specific details are set forth in order to provide a thorough understanding of various disclosed techniques and implementations of such techniques. However, one skilled in the relevant art will recognize that various implementations may be practiced without one or more of these specific details, or with other methods, components, etc.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

The present disclosure is directed to providing a Travel Voucher Authorization Management Web site, management server, and/or mobile presence that enables individual users to provide and/or receive information regarding qualified travel vouchers in order to recover costs associated with remaining uses of those travel vouchers, or to utilize those remaining uses that would otherwise go unused.

As used herein, the term “travel voucher” is used interchangeably with “transportation voucher,” and may include any physical or electronic instrument or document indicating or representing authorization to use some or all facilities of a transportation provider. In at least some implementations, such travel vouchers may be qualified by one or more limitations, such as a limited duration (i.e., the travel voucher expires), a defined quantity of available uses, etc. Non-limiting examples of such travel vouchers may include ferry passes, train passes, subway passes, or bus passes. Typically, a travel voucher may be issued by a travel voucher service that is associated with or operated by a particular transportation provider for which the issued travel voucher is intended to be used.

A particular travel voucher may be associated with various characteristics, such as a particular travel location (e.g., a city, state, other geopolitical entity, or region) or travel route (e.g., a specified ferry route between Seattle, Wash. and Vancouver, British Columbia). Additional characteristics associated with a travel voucher may indicate a particular travel type—indicating, for example, that the travel voucher is valid for use by a pedestrian user or a vehicle (and possibly a particular type of vehicle authorized to be transported via the associated travel voucher), or that the travel voucher is associated with particular seating (such as general or reserved) or other accommodation (private or public). Any characteristics associated with a particular transportation service or individual ticket for such transportation service may be associated with a travel voucher.

In addition, a travel voucher may be associated with one or more identifiers, such as may be specific to the travel voucher and may be authenticated by the issuing travel voucher service or the transportation provider for which the issued travel voucher is intended to be used. For example, such identifiers may include textual identifiers (e.g., a numeric or alphanumeric sequence or other textual array) or graphical identifiers (e.g., a unidimensional, two-dimensional or three-dimensional barcode).

Also as used herein, the term “user” may refer to any human or other entity interacting with the TVAM system, with a travel voucher service, or with a transportation provider. A particular user may, at various times and in various circumstances, operate as either a “voucher-acquiring user” or “voucher-providing user,” and may additionally operate as both a “voucher-acquiring user” and “voucher-providing user” simultaneously in certain circumstances.

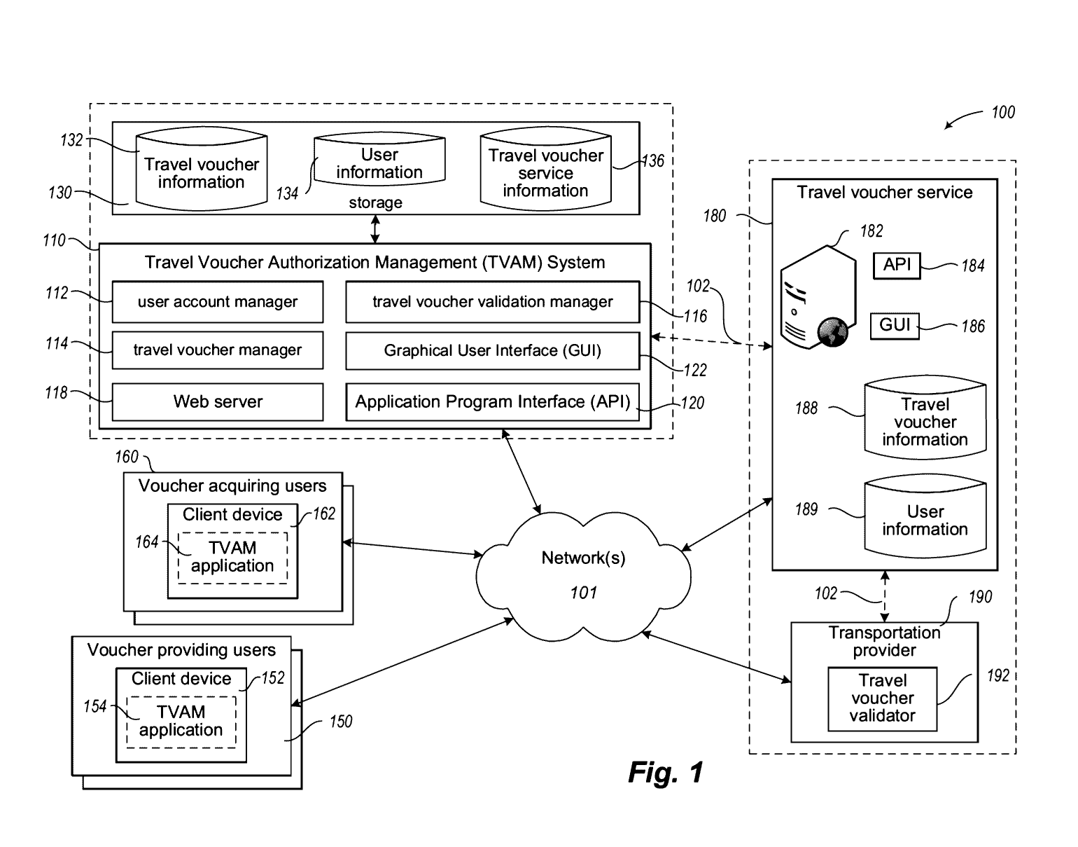

FIG. 1 is a schematic diagram of a networked environment 100 that includes a Travel Voucher Authorization Management (“TVAM”) System 110, voucher-acquiring users 120 of the TVAM system, voucher-providing users 130 of the TVAM system, and various computing systems associated with one or more travel voucher service providers 150 and with one or more transportation providers 170.

In the depicted implementation, the TVAM system 110 includes a user account manager 112, a travel voucher manager 114, and a travel voucher validation manager 116. In addition, the TVAM system includes a Web server 118, an Application Program Interface (“API”) 120, and a Graphical User Interface (“GUI”) 122. The TVAM system is communicatively coupled (locally or remotely) to storage facility 130, which includes travel voucher information database 132, user information database 134 and travel voucher service information database 136. In certain implementations, the storage facility 130 may be incorporated within or otherwise directly operated by the TVAM system; in other implementations, some or all of the functionality provided by the storage facility may be provided by one or more third-party network-accessible storage service providers.

The illustrated example of FIG. 1 includes a number of voucher-providing users 150 and voucher-acquiring users 160 that are each interacting at various times with an implementation of a TVAM system 110 via one or more intervening networks 101.

The interactions of voucher-providing users 150, voucher-acquiring users 160, and other entities with the TVAM system 110 may occur in various ways, such as in an interactive manner via a graphical user interface 122 that is provided by the TVAM system to those users and/or other entities via at least some Web pages of a TVAM system Web site provided by Web server 118. Information provided by the Web site may also be provided in a programmatic manner by one or more client software applications via the Application Program Interface (“API”) 120 provided by the TVAM system that allows computing systems and/or programs to invoke such functionality programmatically, such as using Web services or other network communication protocols. In the illustrated implementation, various interactions between the TVAM system and client computing devices 152 and 162, respectively associated with users 150 and 160, may be performed using a web browser (not shown) or application 154 or 164 each of which may respectively be executing on the associated client device. As used herein, a client computing device associated with a user may be fixed or mobile, and may include instances of various computing devices such as, without limitation, desktop or other computers (e.g., tablets, slates, etc.), database servers, network storage devices and other network devices, smart phones and other cell phones, consumer electronics, digital music player devices, handheld gaming devices, PDAs, pagers, electronic organizers, Internet appliances, television-based systems (e.g., using set-top boxes and/or personal/digital video recorders), and various other consumer products that include appropriate communication capabilities.

The TVAM system may exchange various electronic communications with client computing devices associated with voucher-providing users 150 in order to provide various functionality to such users. For example, a voucher-providing user may typically interact with the TVAM system in order to register a new travel voucher (not shown) with the TVAM service (such as to receive future notifications related to an expiration date or other limitation of the registered travel voucher); in order to provide information regarding a travel voucher that the user wishes to sell or donate via the TVAM system, either after previously registering the travel voucher with the TVAM system or otherwise; in order to receive payment (or an indication of payment) for a travel voucher provided by the user that has been sold or otherwise transferred to a voucher-acquiring user; etc. In addition, the user may interact with the TVAM system to provide various information regarding the user, such as contact information, financial information (such as to facilitate payments provided to or received from the TVAM system), user preference information, location information, etc. In at least some implementations, the TVAM system may allow the user to designate one or more charitable organizations for purposes of donating some or all fees obtained from the user's provided travel vouchers to such charitable organizations. As indicated elsewhere herein, a voucher-providing user 150 may interact with the TVAM system via a client computing device 152 associated with the user, such as via API 120 and a TVAM application 154 executing on the client computing device, or via a web browser executing on the client computing device and a GUI 122 provided by Web server 118. In various implementations, the client computing device 152 may include a visual capture capability, such as to capture and provide to the TVAM service a photograph or other graphical depiction of one or more identifiers associated with the travel voucher being provided by the user to the TVAM system.

The TVAM system may exchange various electronic communications with client computing devices associated with voucher-acquiring users 160 in order to provide various functionality to such users. For example, a voucher-acquiring user may typically interact with the TVAM system in order to request a travel voucher that satisfies particular criteria specified by the user; in order to provide fees to the TVAM system (such as monetary usage fees or other charges associated with acquiring a travel voucher) in exchange for obtaining a requested travel voucher; in order to receive information representative of a travel voucher provided by the TVAM system, such as via electronic communications indicative of one or more identifiers associated with the provided travel voucher. As indicated elsewhere herein, a voucher-providing user may interact with the TVAM system via a client computing device 162 associated with the user 160, such as via API 120 and a TVAM application 164 executing on the client computing device, or via a web browser executing on the client computing device and a GUI 122 provided by the Web server 118. In various implementations, the client computing device may include display capability, such as to display to a transportation provider a visual representation of one or more identifiers associated with the travel voucher. For example, in certain implementations the TVAM system may provide the client computing device 162 with a photograph or other graphical depiction of such identifiers received from the voucher-providing user that provided the travel voucher to the TVAM system. In other implementations, the TVAM system may provide the client computing device with information necessary for the client computing device (such as via the TVAM application 164) to locally generate a graphical depiction of such identifiers for display to the relevant transportation provider.

In certain implementations, a voucher-acquiring user may interact with the TVAM system in order to provide a complaint regarding a travel voucher previously obtained from the TVAM system, such as to indicate that the user has been prevented from using the obtained travel voucher. Such prevention (and resulting complaint) may occur, for example, when a transportation provider attempting to validate the obtained travel voucher determines that the obtained travel voucher has no more remaining uses—possibly indicating that the user who provided the travel voucher to the TVAM system has illicitly used (after ostensibly transferring the travel voucher to the TVAM system) one or more of the remaining uses purportedly still associated with the travel voucher. In at least some implementations, the TVAM system may take various actions based on receiving such a complaint. For example, the TVAM system may prevent the user that provided the relevant travel voucher from providing future travel vouchers to the TVAM system; may determine to withhold fees that would otherwise be paid to that voucher-providing user (and in certain cases may determine to donate such fees to a charitable organization that is separate and distinct from any charitable organization designated by the voucher-providing user); or may select and provide a replacement travel voucher to the complaining user.

In the depicted implementation of FIG. 1, travel voucher service provider 180 includes a Web server 182, and API 184, a GUI 186, travel voucher information database 188, and user information database 189. The travel voucher service provider may, in certain scenarios, be functionally incorporated within and/or operated by a transportation provider 190, such as in situations in which the transportation provider itself issues single tickets and travel vouchers for use within its own transportation system. Furthermore, in an implementation, a travel voucher service provider may operate the TVAM system itself, either as a sole operator or in conjunction with one or more other entities. The TVAM system may interact with the travel voucher service providers 180 in various manners to effectuate various functionality. For example, in various implementations the TVAM system may exchange a variety of electronic communications (such as via the provided API 184, or via the GUI 186 as provided by Web server 182) with the travel voucher service provider, such as to authenticate a travel voucher provided to the TVAM system by a client computing device associated with a voucher-providing user; to validate particular voucher characteristics associated with such a travel voucher; or to validate a complaint received from a voucher-acquiring user that has previously obtained such a travel voucher from the TVAM system.

In situations in which the TVAM system 110 or a travel voucher service provider 180 provides one or more Web sites respectively posted by Web servers 118 and 182, at least some voucher-providing users 150 and/or voucher-acquiring users 160 may perform various additional interactions using such Web sites. For example, a user may use a client computing device (such as client computing devices 152 or 162) to interact with the TVAM system 110 over networks 101, such as to obtain Web pages or other electronic information pages (e.g., HTML-based emails, or other groups of information that are formatted at least in part based on HTML or other formats or markups) from the TVAM system, and to optionally provide various information, as described elsewhere herein. Such users may access a Web site provided by the TVAM system to obtain one or more Web pages, such as to view information about, search for, browse for, and/or provide information related to the user or to travel vouchers and transportation providers, and in certain implementations other information (e.g., user account information, preference information, etc.) stored by the TVAM system 110. In certain implementations, the TVAM system may store various types of user information 162 about such online interactions, including in some cases to record and store information about all interactions and activities performed by the user with respect to the TVAM system.

In the depicted networked environment 100 of FIG. 1, the network 101 is a publicly accessible network of linked networks, possibly operated by various distinct parties, such as the Internet. In other implementations, the network 101 may have other forms. For example, the network 101 may instead be a private network, such as a corporate or university network that is wholly or partially inaccessible to non-privileged users. In still other implementations, the network 101 may include both private and public networks, with one or more of the private networks having access to and/or from one or more of the public networks. Furthermore, the network 101 may include various types of wired and/or wireless networks in various situations. In addition, in this illustrated example of FIG. 1, the users may utilize client computing systems and/or other client devices (not shown) to interact with the TVAM system 110 to obtain various described functionality via the network 101, and in doing so may provide various types of information to the TVAM system 110. Moreover, in certain implementations, the various users and providers of the networked environment 100 may interact with the TVAM system and/or one or more other users and providers using an optional private or dedicated connection, such as one of dedicated connections 102. For example, dedicated connections 102 may include one or more VPN (Virtual Private Network) connections.

For illustrative purposes, an example is described below in which a specific implementation of a TVAM system provides various specific types of capabilities and functionalities with respect to managing the authorization and transfer of travel vouchers, and interacts with voucher-providing users and voucher-acquiring users in specific types of ways. However, those skilled in the art will appreciate that the techniques described herein can be used in a wide variety of other situations, including with other types of vouchers, with types of programmatic interfaces and/or access mechanisms that do not use Web services, and in situations other than with a travel voucher service provider or transportation provider, and that the techniques described herein are not limited to the exemplary details provided.

As one exemplary scenario, suppose that a first user Avery purchases a ferry pass (i.e., a travel voucher) from a ferry service based in Seattle, Wash. In this example, the Seattle ferry service acts as both a transportation provider (by operating ferries for transporting pedestrians and vehicles) and as a travel voucher service provider (by issuing tickets and travel vouchers for use by passengers of the ferry service). The ferry pass Avery purchases is valid for one month from the date of purchase, and includes 10 uses, indicating that if Avery does not use all 10 uses prior to the expiration date, the remaining uses associated with the ferry pass are void. In this example, the ferry pass is associated with additional characteristics: a specific travel route (Seattle to Vashon Island) and a travel type (pedestrian or “walk-on,” indicating that Avery will not drive a vehicle onto the ferry for trips using the ferry pass). The particular ferry pass Avery purchases includes an identifier in the form of a two-dimensional barcode, such as for use by the ferry service when validating the ferry pass each time it is used.

Shortly after purchasing the ferry pass, Avery uses a TVAM mobile application executing on her smartphone (i.e., client computing device) to interact with the TVAM system in order to register the ferry pass. In this example, the client computing device associated with Avery includes GPS-based location capabilities, allowing the TVAM mobile application to provide electronic communications indicating Avery's geographical location to the TVAM system. Based on such information, the TVAM system may provide default values for various information requested from Avery during the travel voucher registration process. For example, the TVAM system may provide a list of transportation providers in the Seattle area; if the location information furnished by the client computing device indicates that Avery is near the Seattle ferry terminal, the TVAM system may provide default values relevant to Seattle-area ferry passes in response to Avery initiating contact with the TVAM system.

Because it is her first use of the TVAM system, Avery provides various personal information using the TVAM mobile application, such as her name, address, telephone number, etc. In certain implementations, Avery may also provide various user preferences, including preferences related to payment processing that may be used by the TVAM system for facilitating payments to or from a financial account based on Avery's interactions with the TVAM system. In at least one implementation, the TVAM mobile application may provide certain aspects of Avery's personal information and user preferences to the TVAM system without the need for Avery to manually enter such details, based on information already stored on her smartphone or elsewhere.

As part of registering the new ferry pass, Avery uses the camera functionality of her smartphone to provide a photograph of the ferry pass, including any details printed on the ferry pass along with the two-dimensional barcode identifier. Upon receiving the photograph, the TVAM system identifies the expiration date, the number of uses, and the other voucher characteristics associated with the ferry pass (including information representative of the two-dimensional barcode identifier) and stores the identified information (such as via storage facility 130 as depicted in FIG. 1) for future use. In this example, Avery requests that she be reminded when the registered ferry pass is due to expire in one week. The TVAM system schedules a reminder (such as via travel voucher manager 114 as depicted in FIG. 1) to be initiated on that date in accordance with Avery's user preferences—in this case, such preferences indicate that a text message will be sent to Avery's smartphone and an email message will be sent to her designated email address.

In this example, as part of registering the new ferry pass and storing its information, the TVAM system exchanges a series of electronic communications with a computing system associated with the Seattle ferry service in order to authenticate the ferry pass and to validate the identified voucher characteristics associated with that ferry pass. For example, with reference to FIG. 1, the travel voucher validation manager 116 may exchange the series of electronic communications with the Seattle ferry service (the travel voucher service provider 180) via API 184 or GUI 186. In other implementations, one or more representatives of a TVAM service operating the TVAM system may manually perform various operations to exchange electronic communications with a travel voucher service provider in order to authenticate a travel voucher and validate any associated voucher characteristics. By authenticating the ferry pass with the Seattle ferry service, the TVAM system verifies that the identifier represented by the two-dimensional barcode contained in Avery's provided photograph is valid. By validating the travel voucher characteristics, the TVAM system confirms that the identified voucher characteristics it has associated with the registered ferry pass matches those voucher characteristics indicated by the Seattle ferry service are associated with that same identifier.

Over the course of the next three weeks, Avery uses her ferry pass for a total of eight trips using the Seattle ferry system to travel to and return from Vashon Island. At a time one week prior to the expiration date of the ferry pass Avery registered with TVAM system, the TVAM system sends the text message and email message reminders as scheduled. Upon receiving the reminders from the TVAM system, Avery determines that she will not use the two remaining uses still associated with the ferry pass before it expires. Avery uses her TVAM mobile application on her smartphone to request that the TVAM system attempt to sell the remaining uses associated with the ferry pass.

In response to Avery's request, the TVAM system again exchanges a series of electronic communications with computing systems of the Seattle ferry service to authenticate the ferry pass and to validate its characteristics. As part of such validation, the TVAM system determines that the registered ferry pass is now associated with two remaining uses. Based on Avery's request, on the authentication of the ferry pass and on the validation of its associated voucher characteristics, the TVAM system updates the stored information associated with the ferry pass to indicate that the ferry pass is available and has two remaining uses. In at least some implementations, the TVAM system provides a notification to Avery, such as to indicate that the TVAM system will attempt to match her ferry pass with a distinct other user of the TVAM system, and/or instructing her that she should now destroy or discard her physical ferry pass, or otherwise refrain from using the ferry pass or assisting or enabling others to use the ferry pass.

Several days later, a second user Bob is enjoying a sunny spring day in Seattle, and decides to take a ferry trip to Vashon Island with his wife. Bob notices that the fees for purchasing single tickets from the Seattle ferry service are significantly higher than the fees associated with the same type of travel and ferry route when purchasing multi-trip ferry passes from the Seattle ferry service. However, Bob knows that he will not use the ferry service often enough to warrant the cost of purchasing a ferry pass. Bob uses a web browser executing on his portable tablet (i.e., client computing device) to interact with the TVAM system Web site (such as that provided by Web server 118 via GUI 122 as depicted in FIG. 1). As part of his interactions with the Web site, Bob inquires as to whether there are any ferry passes available meeting his specified criteria: two pedestrian passengers traveling that day to Vashon Island from the Seattle ferry terminal. The TVAM system executes one or more search queries of its pool of available travel vouchers, which includes stored information related to multiple ferry passes issued by the Seattle ferry service and associated with Bob's anticipated travel route from Seattle to Vashon Island. The TVAM system identifies Avery's ferry pass and three other ferry passes as satisfying the criteria specified by Bob. While all four identified ferry passes satisfy such specified criteria, however, the TVAM system selects Avery's ferry pass based on its associated expiration date occurring earlier than the other three identified ferry passes.

In this example, as part of selecting Avery's ferry pass, the TVAM system again initiates a series of electronic communications with the computing systems of the Seattle ferry service to authenticate the ferry pass and to validate its associated voucher characteristics, including verifying that the ferry pass is still associated with two remaining uses. In certain implementations, the TVAM system may determine to authenticate and validate some or all of the other three identified ferry passes that satisfy Bob's specified criteria prior to selecting one or more of those ferry passes for transfer to Bob. In various implementations, the TVAM system may identify and/or select one or more travel vouchers from an available pool of such vouchers based on various criteria, such as based on particular criteria specified by a voucher-acquiring user; based on an expiration date of the identified/selected travel voucher being in closer proximity to a specified travel date than the respective expiration dates associated with other travel vouchers in the available pool; based on a number of travelers, such as to match the number of remaining uses associated with an available travel voucher; etc. In some implementations, the TVAM system may identify and/or select one or more travel vouchers from an available pool of such vouchers based on an indication from one or more of the voucher-providing users of the identified ferry passes of being agreeable to accepting reduced compensation for the remaining usage associated with his or her ferry pass. In other implementations, the TVAM system may display for user selection a list of the identified ferry passes and prices associated with each, which may be based at least in part on input from the voucher-providing users.

In this example, as part of transferring the selected ferry pass to Bob the TVAM system obtains monetary payment from Bob by charging monetary usage fees associated with the selected ferry pass to a financial account associated with a credit card number he provides via the web browser executing on his portable tablet. Upon confirmation of receiving the indicated payment, the TVAM system provides Bob, via the web browser, with a graphical depiction of the two-dimensional barcode identifier associated with the ferry pass originally purchased by Avery. When it is time to board the ferry for Vashon Island, Bob displays his portable tablet showing the two-dimensional barcode identifier to a representative of the Seattle ferry service, who validates the barcode. In various implementations, an identifier specific to a travel voucher being transferred to a voucher-acquiring user may be provided in other manners, as described elsewhere herein. For example, a voucher-acquiring user may choose to generate a physical representation of the identifier associated with a travel voucher transferred to the voucher-acquiring user, such as by printing a copy of that identifier for validation by the transportation provider.

In the implementation of the TVAM system in this described example, the TVAM system provides a notification to Avery that her ferry pass has been transferred successfully, and additionally provides payment to Avery for at least a portion of the monetary usage fees obtained from Bob. In certain implementations, may or may not issue such notifications, and may delay payment to a voucher-providing user for a defined period of time, or until one or more criteria are satisfied. For example, the TVAM system may delay payment to the voucher-providing user until the expiration date of the registered travel voucher has occurred; until a defined number of days has passed since transferring the travel voucher to another user of the TVAM system; etc. Furthermore, as discussed elsewhere herein, in certain circumstances and implementations the TVAM system may provide payment to parties other than the voucher-providing user originally associated with the transferred travel voucher, such as a charitable organization or other parties designated by the voucher-providing user.

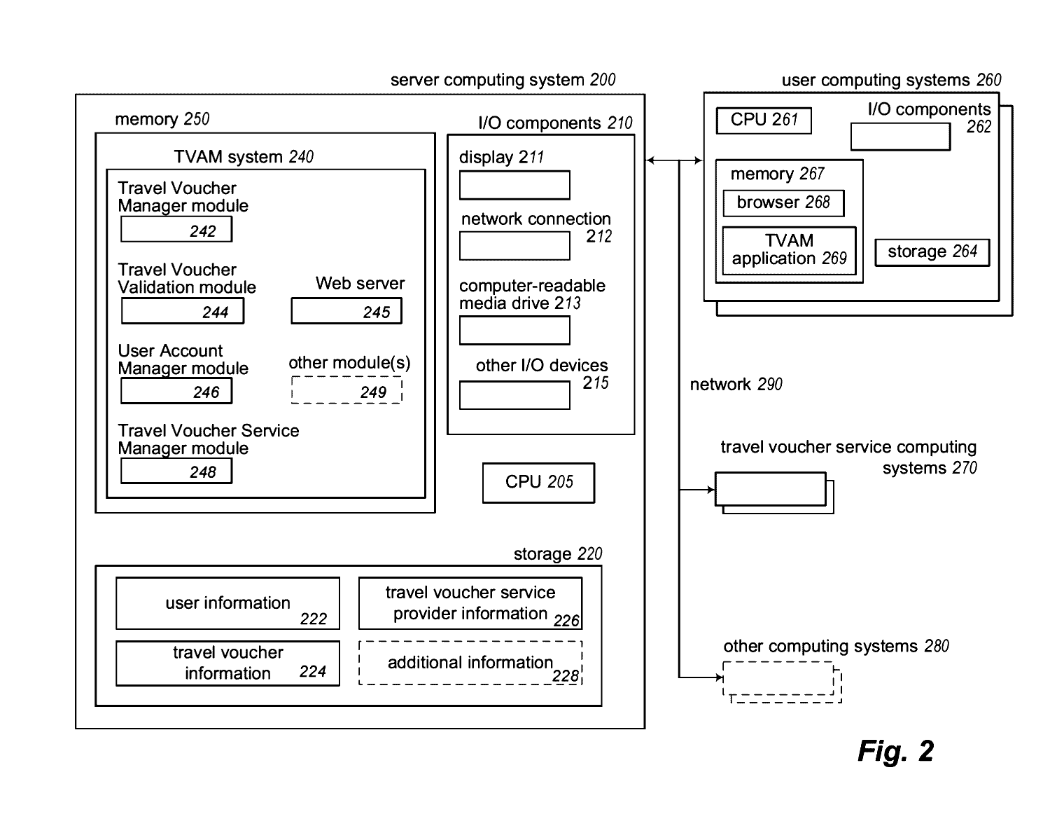

FIG. 2 is a block diagram illustrating component-level functionality provided by a plurality of electronic circuits that, when in combined operation, are suitable for performing and configured to perform at least some of the techniques described herein. In the particular implementation depicted, the plurality of electronic circuits is at least partially housed within a server computing system 200 executing an implementation of a TVAM system. The server computing system 200 includes one or more central processing units (“CPU”) or other processors 205, various input/output (“I/O”) components 210, storage 220, and memory 250, with the illustrated I/O components including a display 211, a network connection 212, a computer-readable media drive 213, and other I/O devices 215 (e.g., keyboards, mice or other pointing devices, microphones, speakers, GPS receivers, etc.). The server computing system 200 and TVAM system 240 may communicate with other computing systems via one or more networks 290 (e.g., the Internet, one or more cellular telephone networks, etc.), such as user computing systems 260, travel voucher service provider computing systems 270, and other computing systems 280. Some or all of the other computing systems may similarly include some or all of the types of components illustrated for server computing system 200 (e.g., to have a TVAM system client application 269 executing in memory 267 of a member user computing system 260 in a manner analogous to TVAM system 240 in memory 250).

In the illustrated implementation, an embodiment of the TVAM system 240 executes in memory 250 in order to perform at least some of the described techniques, such as by using the processor(s) 205 to execute software instructions of the system 240 in a manner that configures the processor(s) 205 and computing system 200 to perform automated operations that implement those described techniques. As part of such automated operations, the TVAM system 240 and/or other optional programs or modules 249 executing in memory 250 may store and/or retrieve various types of data, including in the example database data structures of storage 220. In this example, the data used may include various types of user information in database (“DB”) 222, various types of travel voucher information in DB 224, various types of travel voucher service provider information in DB 226, and various types of additional information in DB 228, such as various fee-based or financial information related to one or more users or service providers associated with the TVAM system.

It will be appreciated that computing system 200 and systems 260 and 270 are merely illustrative and are not intended to limit the scope of the present invention. The systems and/or devices may instead each include multiple interacting computing systems or devices, and may be connected to other devices that are not specifically illustrated, including through one or more networks such as the Internet, via the Web, or via private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable and other fitness tracking devices, biometric monitoring devices, digital music player devices, handheld gaming devices, PDAs, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated TVAM system 240 may in some implementations be distributed in various modules. Similarly, in some implementations, some of the functionality of the TVAM system 240 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other implementations some or all of the software modules and/or systems may execute in memory on another device and communicate with the illustrated computing systems via inter-computer communication. Thus, in some implementations, some or all of the described techniques may be performed by hardware means that include one or more processors and/or memory and/or storage when configured by one or more software programs (e.g., the TVAM system 240 and/or TVAM client software executing on devices 260 and/or 270) and/or data structures, such as by execution of software instructions of the one or more software programs and/or by storage of such software instructions and/or data structures. Furthermore, in some implementations, some or all of the systems and/or modules may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some implementations be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other implementations. Accordingly, implementations of the present disclosure may be practiced with other computer system configurations.

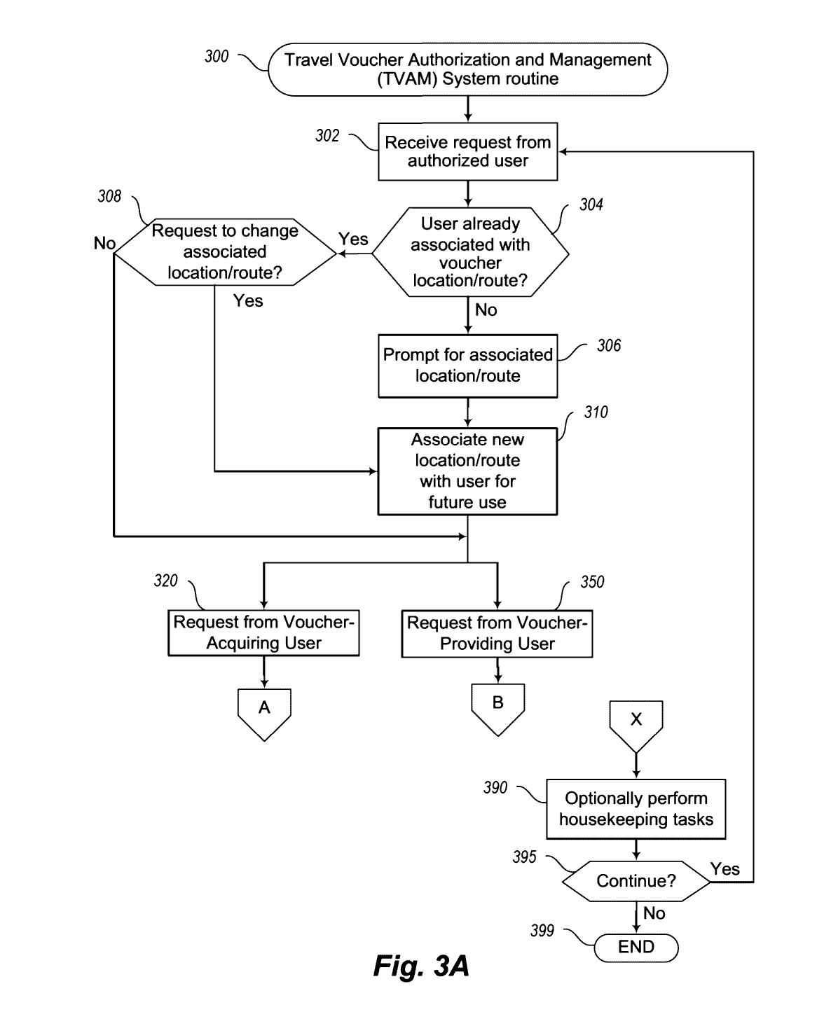

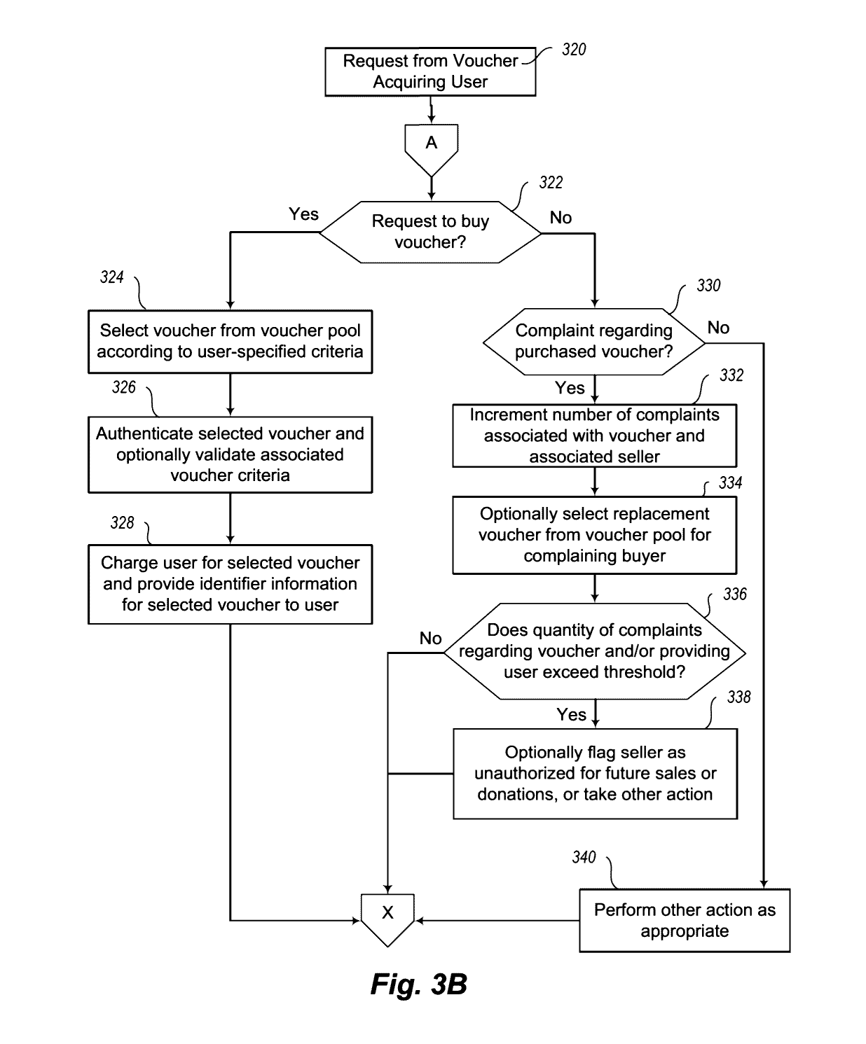

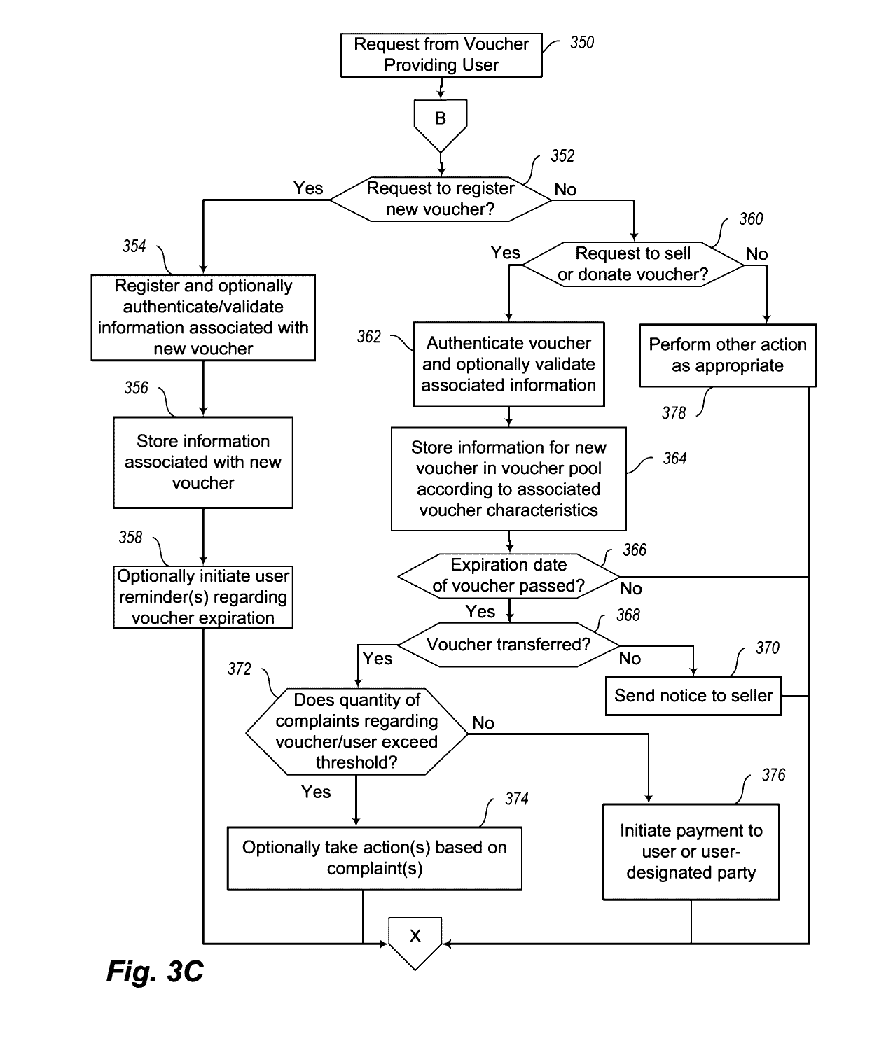

FIGS. 3A-3B depict an exemplary method 300 of operation of a TVAM system, such as may be performed by one or more modules of the TVAM system 110 of the networked environment 100 depicted by FIG. 1, and/or the TVAM system 240 executed by the server computing system 200 of FIG. 2.

The method 300 starts at 302, in which a processor-based device receives a request from an authorized user, such as a user that has previously registered with an implementation of the TVAM system or newly created an account with an implementation of the TVAM system. At 304, the processor-based device determines whether the user is already associated with a location or travel route, such as based by information previously provided by the user or provided as part of the received request. If it is determined that the user is not yet associated with a location or travel route, at 306 the processor-based device prompts the user to provide one or more locations or travel routes. If at 304 it is determined that the user is already associated with a location or travel route, at 308 the processor-based device determines whether the received request is a request to change the location or travel route already associated with the user.

If it is determined at 308 that the received request is to change the location or travel route associated with the user, or in response to the prompt for such location or travel route information at 306, at 310 the information stored in association with the authorized user is updated to indicate the new location and/or travel route for future use.

At 320, the processor-based device determines that the request is from a voucher-acquiring user, and (with reference to FIG. 3B) passes control to 322, in which the processor-based device determines whether the received request is to purchase a travel voucher. If so, at 324 the processor-based device selects a travel voucher from a pool of available travel vouchers in accordance with criteria specified by the voucher-acquiring user, such as criteria specified in information included within the received request or further electronic communications associated with the request. At 326, the processor-based device authenticates the selected travel voucher and optionally validates voucher criteria associated with the selected travel voucher. Control then passes to 328, in which the processor-based device obtains one or more fees from the voucher-acquiring user and provides information indicative of one or more identifiers associated with the selected travel voucher to the voucher-acquiring user, such as to enable the voucher-acquiring user to use the selected travel voucher.

If at 322 it was determined that the received request was not to purchase a travel voucher, at 330 the processor-based device determines whether the request is to enter a complaint regarding a previously acquired travel voucher, such as to indicate that the user's use of the previously acquired travel voucher has been prevented (if, for example, the previously acquired travel voucher is no longer associated with the quantity of remaining uses purportedly associated with the travel voucher at the time of its transfer to the complaining user). If so, at 332 the processor-based device increments a number of complaints associated with the relevant travel voucher and with the voucher-providing user associated with that travel voucher. At 334, the processor-based device optionally selects a replacement travel voucher for the complaining voucher-acquiring user from the available travel voucher pool. At 336, the processor-based device determines whether the quantity of complaints associated with the indicated travel voucher or associated voucher-providing user exceed a defined threshold. If so, at 338 the processor-based device optionally takes action based on the complaint, such as preventing the associated voucher-providing user from providing future travel vouchers to the TVAM system, withholding fees that would otherwise be paid to that voucher-providing user, etc.

If at 330 it was determined that the received request was not a request to enter a complaint regarding a previously acquired travel voucher, control passes to 340, in which the processor-based device optionally performs any other actions as appropriate.

If at 320 it was not determined that the received request was from a voucher-acquiring user, at 350 (with reference to FIG. 3C) the processor-based device determines that the request is from a voucher-providing user, and passes control to 352 to determine whether the received request is to register a new travel voucher. If so, at 354 the processor-based device registers and optionally authenticates/validates the information purportedly associated with the travel voucher to be registered. At 356, the processor-based device stores the information associated with the new travel voucher; at 358, the processor-based device optionally configures and initiates one or more reminders for the voucher-providing user regarding the travel voucher, such as based on the expiration date associated with the travel voucher.

If at 352 it was determined that the received request was not a request to register a new travel voucher, at 360 the processor-based device determines whether the request is to sell or donate a travel voucher. If so, at 362 the processor-based device authenticates the travel voucher (by exchanging electronic communications with an issuing travel voucher service provider, such as travel voucher service provider 180 of FIG. 1) and optionally validates voucher characteristics associated with the travel voucher (again, by exchanging electronic communications with an issuing travel voucher service provider associated with the travel voucher). At 364, the processor-based device stores information regarding the travel voucher, including an indication that the travel voucher is available for transfer and information indicative of the voucher characteristics associated with the travel voucher.

If at 366 it is determined (either in response to a user request or as may be otherwise initiated by the processor-based device) that the expiration date of the travel voucher has occurred, at 368 the processor-based determines whether the travel voucher was transferred to a voucher-acquiring user. If it is determined that the travel voucher was not transferred, at 370 the processor-based device transmits a notification to the voucher-providing user associated with the travel voucher, such as may indicate that the travel voucher was not transferred and that no corresponding fees will be provided. If at 368 it is determined that the voucher was transferred to a voucher-acquiring user, at 372 the processor-based device further determines if a quantity of complaints regarding the travel voucher or associated voucher-providing user exceeds a defined threshold. If not, at 376 the processor-based device initiates payment to the voucher-providing user or another party designated by the voucher-providing user. However, if at 372 it is determined that the quantity of complaints does exceed the defined threshold, the processor-based device optionally takes one or more actions based the complaint threshold being exceeded. For example, in certain implementations, the processor-based device may deduct one or more fines from those fees to be provided to the voucher-providing user; may withhold such fees entirely; or may provide such fees to a party other than those designated by the voucher-providing user.

If at 360 it was determined that the received request was not a request to sell or donate a travel voucher, control passes to 378, in which the processor-based device optionally performs any other actions as appropriate.

After 328, 338, 340, 358, 374, 376, or 378, or if it was determined at 336 that the quantity of complaints does not exceed the defined threshold, control passes to (with reference to FIG. 3A) 390 to optionally perform any other actions as appropriate, such as any housekeeping tasks. In block 395, the processor-based device determines whether to continue, such as in response to an explicit indication to terminate. If it is to continue, control returns to block 302 to await additional instructions or requests, and if not proceeds to step 399 and ends.

It will be appreciated that in some implementations the functionality provided by the routines discussed above may be provided in alternative ways, such as being split among more routines or consolidated into fewer routines. Similarly, in some implementations illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other implementations the operations may be performed in other orders and in other manners. Any data structures discussed above may also be structured in different manners, such as by having a single data structure split into multiple data structures or by having multiple data structures consolidated into a single data structure. Similarly, in some implementations illustrated data structures may store more or less information than is described, such as when other illustrated data structures instead lack or include such information respectively, or when the amount or types of information that is stored is altered.

From the foregoing it will be appreciated that, although specific implementations have been described herein for purposes of illustration, various modifications may be made without deviating from the spirit and scope of the invention. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so implemented.

According to one implementation, a computer-implemented method may be summarized as including: receiving, by one or more computing systems configured to provide a travel voucher authorization management system, one or more first electronic communications sent via one or more computer networks by a client computing device of a first user, the received communications indicating a travel voucher issued by a travel voucher service provider and associated with voucher characteristics that include one or more identifiers, a travel route, a travel type, an expiration date, and a quantity of remaining uses that is less than an original quantity of uses associated with the indicated travel voucher; validating, by the one or more configured computing systems via one or more second electronic communications transmitted over the one or more computer networks, the indicated travel voucher via a communications interface of the travel voucher service provider; storing, by the one or more configured computing systems and based at least in part on the validating, information representing the associated voucher characteristics of the indicated travel voucher; after the storing, receiving, by the one or more configured computing systems via one or more second electronic communications sent over the one or more computer networks from a client computing device of a distinct second user, a request for a travel voucher satisfying one or more specified criteria, the specified criteria including at least one of a specified quantity of uses, a specified travel route, and a specified travel date; selecting, by the one or more configured computing systems and based at least in part on the specified criteria, the indicated travel voucher from a plurality of available travel vouchers; responsive to the received request and based at least in part on the selecting of the indicated travel voucher, transferring the remaining uses associated with the selected travel voucher to the second user (the transferring of the remaining uses including providing, by the one or more configured computing systems via one or more additional electronic communications sent over the one or more computer networks to the client computing device of the second user, information indicative of at least the one or more identifiers of the selected travel voucher, and obtaining one or more monetary usage fees from the second user in exchange for the remaining uses); and providing at least some of the obtained monetary usage fees to the first user.

Each of the plurality of available travel vouchers may be associated with a respective expiration date. The specified criteria may include a specified travel date, and the selecting of the indicated travel voucher may be based at least in part on the expiration date being in closer proximity to the specified travel date than the respective expiration dates associated with other respective ones of the plurality of available travel vouchers.

The specified criteria of the received request may include a specified number of travelers, and the selecting of the indicated travel voucher may be based at least in part on matching the quantity of remaining uses associated with the indicated travel voucher with the specified number of travelers.

According to another implementation, a computer-implemented method may be summarized as including: receiving, by one or more computing systems configured to provide a travel voucher authorization management system, one or more first electronic communications sent over one or more computer networks from a client device of a user, the first electronic communications indicating a request that specifies criteria for a desired travel voucher; selecting, by the one or more configured computing systems and from a plurality of available travel vouchers provided to the travel voucher authorization management system, at least one travel voucher associated with multiple voucher characteristics that satisfy at least some of the specified criteria, the multiple voucher characteristics including at least a quantity of remaining uses that is less than an original quantity of uses associated with the at least one travel voucher; transmitting, by the one or more configured computing systems to the client device of the user via the one or more computer networks, one or more second electronic communications that include information representing the selected at least one travel voucher in a manner that enables use of the selected at least one travel voucher by the user; and providing at least a portion of one or more monetary usage fees obtained from the user to a distinct other user that provided the at least one selected travel voucher.

The computer-implemented method may further include, prior to receiving the request: receiving, by the one or more configured computing systems, information regarding the at least one travel voucher from the distinct other user; authenticating, by the one or more configured computing systems and via the one or more computer networks, the at least one travel voucher via one or more additional electronic communications with a travel voucher service provider, the authenticating of the at least one travel voucher including validation of at least one of the multiple voucher characteristics associated with the at least one travel voucher; storing, by the one or more configured computing systems and based at least in part on the authenticating of the at least one travel voucher, information representing the at least one travel voucher. The multiple voucher characteristics associated with the at least one travel voucher may include one or more identifiers of the at least one travel voucher, the one or more identifiers including at least one of a textual identifier and a graphical identifier, and the storing of the information representing the at least one travel voucher may include storing the one or more identifiers. The at least one travel voucher may be issued by the travel voucher service provider, and the authenticating of the at least one travel voucher may include one or more interactions with a programmatic interface of the travel voucher service provider. The at least one travel voucher may be issued by the travel voucher service provider, and the authenticating of the at least one travel voucher may include one or more interactions with a graphical user interface of the travel voucher service provider.

Each of the plurality of available travel vouchers may be associated with one or more identifiers and with voucher characteristics that include at least one of a group that includes a travel route, an expiration date, and a quantity of remaining uses.

Each of the plurality of available travel vouchers may be associated with a respective expiration date, the specified criteria may include a specified travel date, and the selecting of the at least one travel voucher may be based at least in part on the expiration date being in closer proximity to the specified travel date than the respective expiration dates associated with other respective ones of the plurality of available travel vouchers.

The associated voucher characteristics of the at least one travel voucher may further include a travel type, the specified criteria may further include a specified travel type, and the selecting of the at least one travel voucher may be based at least in part on matching the travel type associated with the at least one travel voucher with the specified travel type.

The specified criteria may include a specified number of travelers, and the selecting of the at least one travel voucher may be based at least in part on matching the quantity of remaining uses associated with the at least one travel voucher with the specified number of travelers.

The at least one travel voucher may be associated with one or more identifiers that include at least one of a textual identifier and a graphical identifier, and the transmitting of the information representing the selected at least one travel voucher may include providing at least one of the one or more identifiers to the client device of the user. The client device of the user may be a mobile device associated with the user, and the enabled use of the selected at least one travel voucher may include displaying the at least one identifier, via an application associated with the travel voucher authorization management system executing on the associated mobile device, for presentation to a transportation provider.

At least some of the first electronic communications and the second electronic communications may be provided via a programmatic interface of the travel voucher authorization management system.

At least some of the first electronic communications and the second electronic communications may be provided via one or more user interactions with a graphical user interface of the travel voucher authorization management system.

The computer-implemented method may further include, after the transmitting of the one or more second electronic communications, receiving one or more additional communications indicating a complaint that the enabled use of the selected at least one travel voucher by the user has been prevented. The computer-implemented method may further include, based at least in part on the indicated complaint, determining to prevent the distinct other user that provided the at least one selected travel voucher from providing future travel vouchers to the travel voucher authorization management system. The computer-implemented method may further include, based at least in part on the indicated complaint, determining to forward the portion of the one or more monetary usage fees obtained from the user to a party other than the distinct other user that provided the at least one selected travel voucher. The computer-implemented method may further include, based at least in part on the indicated complaint, selecting a distinct other travel voucher that satisfies at least some of the specified criteria, and transmitting additional information representing the selected distinct other travel voucher to the client device of the user to enable use of the selected distinct other travel voucher by the user.

The providing of the portion of the obtained monetary usage fees to the distinct other user may include providing the portion of the obtained monetary usage fees to one or more charitable organizations designated by the distinct other user.

According to another implementation, a non-transitory computer-readable medium may be summarized as including having stored contents that, when executed, configure a computing system to: receive, by the configured computing system, one or more first electronic communications sent over one or more computer networks from a client device of a user, the first electronic communications specifying one or more criteria for a travel voucher requested by the user; identify, by the configured computing system and from among a plurality of available travel vouchers, a travel voucher associated with multiple voucher characteristics that satisfy at least some of the specified criteria; transmit, by the configured computing system to the client device of the user via the one or more computer networks, one or more second electronic communications that include information representing the identified travel voucher for use of the identified travel voucher by the user; and provide, by the configured computing system and to a distinct other user that provided the identified travel voucher, at least a portion of monetary usage fees obtained from the user for use of the identified travel voucher.

The stored contents may further configure the computing system to: receive information regarding the identified travel voucher from the distinct other user; authenticate the identified travel voucher via a remote travel voucher service provider, the authentication of the identified travel voucher including validation of one or more of the multiple voucher characteristics associated with the identified travel voucher; and store, based at least in part on the authentication of the identified travel voucher, information representing the identified travel voucher.

Each of the plurality of available travel vouchers may be associated with one or more identifiers and with voucher characteristics that include one or more of a group that includes a travel route, a travel type, an expiration date, and a quantity of remaining uses.

Each of the plurality of available travel vouchers may be associated with a respective expiration date, the specified criteria for the requested travel voucher may include a specified travel date, and the expiration date of the identified travel voucher may be in closer proximity to the specified travel date than the respective expiration dates associated with other respective ones of the plurality of available travel vouchers.

The stored contents may further configure the computing system to receive, after the transmitting of the one or more second electronic communications, one or more additional communications indicating that the enabled use of the selected at least one travel voucher by the user has been prevented. The stored contents may further configure the computing system to identify, based at least in part on receiving the one or more additional communications, a distinct second travel voucher that satisfies at least some of the specified criteria, and transmit additional information representing the identified distinct second travel voucher to the client device of the user to enable use of the identified distinct second travel voucher.

According to yet another implementation, a system may be summarized as including one or more processors and at least one memory, the memory including instructions that, upon execution by at least one of the one or more processors, cause the system to: receive one or more first electronic communications from a client device of a user, the first electronic communications indicating a request that specifies criteria for a desired travel voucher; select at least one travel voucher from a plurality of available travel vouchers, the selection of the at least one travel voucher being based at least in part on determining that multiple voucher characteristics associated with the at least one travel voucher satisfy at least some of the specified criteria; transmitting to the client device of the user via the one or more computer networks one or more second electronic communications that include information representing the selected at least one travel voucher in a manner that enables use of the selected at least one travel voucher by the user; and provide at least a portion of one or more fees obtained from the user for the enabled use of the selected at least one travel voucher to a distinct other user that provided the at least one selected travel voucher. The instructions may further cause the system to: receive information regarding the selected at least one travel voucher from the distinct other user; authenticate the selected at least one travel voucher via a remote travel voucher service provider, the authentication of the selected at least one travel voucher including validation of one or more of the multiple voucher characteristics associated with the selected at least one travel voucher; and store, based at least in part on the authentication of the selected travel voucher, information representing the selected travel voucher.

What is claimed is:

1. A computer-implemented method comprising:
receiving, by one or more computing systems configured to provide a travel voucher authorization management system, one or more first electronic communications sent via one or more computer networks by a client computing device of a first user, the received communications indicating a travel voucher issued by a travel voucher service provider and associated with voucher characteristics that include one or more identifiers, a travel route, a travel type, an expiration date, and a quantity of remaining uses that is less than an original quantity of uses associated with the indicated travel voucher;
validating, by the one or more configured computing systems via one or more second electronic communications transmitted over the one or more computer networks, the indicated travel voucher via a communications interface of the travel voucher service provider;
storing, by the one or more configured computing systems and based at least in part on the validating, information representing the associated voucher characteristics of the indicated travel voucher;
after the storing, receiving, by the one or more configured computing systems via one or more second electronic communications sent over the one or more computer networks from a client computing device of a distinct second user, a request for a travel voucher satisfying one or more specified criteria, the specified criteria including at least one of a specified quantity of uses, a specified travel route, and a specified travel date;
selecting, by the one or more configured computing systems and based at least in part on the specified criteria, the indicated travel voucher from a plurality of available travel vouchers;
responsive to the received request and based at least in part on the selecting of the indicated travel voucher, transferring the remaining uses associated with the selected travel voucher to the second user, the transferring of the remaining uses including:
providing, by the one or more configured computing systems via one or more additional electronic communications sent over the one or more computer networks to the client computing device of the second user, information indicative of at least the one or more identifiers of the selected travel voucher, and
obtaining one or more monetary usage fees from the second user in exchange for the remaining uses; and
providing at least some of the obtained monetary usage fees to the first user.

2. The computer-implemented method of claim 1, wherein each of the plurality of available travel vouchers is associated with a respective expiration date, wherein the specified criteria include a specified travel date, and wherein the selecting of the indicated travel voucher is based at least in part on the expiration date being in closer proximity to the specified travel date than the respective expiration dates associated with other respective ones of the plurality of available travel vouchers.

3. The computer-implemented method of claim 1 wherein the specified criteria of the received request include a specified number of travelers, and wherein the selecting of the indicated travel voucher is based at least in part on matching the quantity of remaining uses associated with the indicated travel voucher with the specified number of travelers.

4. A computer-implemented method comprising:
receiving, by one or more computing systems configured to provide a travel voucher authorization management system, one or more first electronic communications sent over one or more computer networks from a client device of a user, the first electronic communications indicating a request that specifies criteria for a desired travel voucher;
selecting, by the one or more configured computing systems and from a plurality of available travel vouchers provided to the travel voucher authorization management system, at least one travel voucher associated with multiple voucher characteristics that satisfy at least some of the specified criteria, wherein the multiple voucher characteristics include at least a quantity of remaining uses that is less than an original quantity of uses associated with the at least one travel voucher;
transmitting, by the one or more configured computing systems to the client device of the user via the one or more computer networks, one or more second electronic communications that include information representing the selected at least one travel voucher in a manner that enables use of the selected at least one travel voucher by the user; and
providing at least a portion of one or more monetary usage fees obtained from the user to a distinct other user that provided the at least one selected travel voucher.

5. The computer-implemented method of claim 4 further comprising, prior to receiving the request:
receiving, by the one or more configured computing systems, information regarding the at least one travel voucher from the distinct other user;
authenticating, by the one or more configured computing systems and via the one or more computer networks, the at least one travel voucher via one or more additional electronic communications with a travel voucher service provider, the authenticating of the at least one travel voucher including validation of at least one of the multiple voucher characteristics associated with the at least one travel voucher;
storing, by the one or more configured computing systems and based at least in part on the authenticating of the at least one travel voucher, information representing the at least one travel voucher.

6. The computer-implemented method of claim 5 wherein the multiple voucher characteristics associated with the at least one travel voucher include one or more identifiers of the at least one travel voucher, the one or more identifiers including at least one of a textual identifier and a graphical identifier, and wherein the storing of the information representing the at least one travel voucher includes storing the one or more identifiers.

7. The computer-implemented method of claim 5 wherein the at least one travel voucher is issued by the travel voucher service provider, and wherein the authenticating of the at least one travel voucher comprises one or more interactions with a programmatic interface of the travel voucher service provider.

8. The computer-implemented method of claim 5 wherein the at least one travel voucher is issued by the travel voucher service provider, and wherein the authenticating of the at least one travel voucher comprises one or more interactions with a graphical user interface of the travel voucher service provider.

9. The computer-implemented method of claim 4 wherein each of the plurality of available travel vouchers is associated with one or more identifiers and with voucher characteristics that include at least one of a group that includes a travel route, an expiration date, and a quantity of remaining uses.

10. The computer-implemented method of claim 4 wherein each of the plurality of available travel vouchers is associated with a respective expiration date, wherein the specified criteria include a specified travel date, and wherein the selecting of the at least one travel voucher is based at least in part on the expiration date being in closer proximity to the specified travel date than the respective expiration dates associated with other respective ones of the plurality of available travel vouchers.

11. The computer-implemented method of claim 4 wherein the associated voucher characteristics of the at least one travel voucher further include a travel type, wherein the specified criteria further include a specified travel type, and wherein the selecting of the at least one travel voucher is based at least in part on matching the travel type associated with the at least one travel voucher with the specified travel type.

12. The computer-implemented method of claim 4 wherein the specified criteria include a specified number of travelers, and wherein the selecting of the at least one travel voucher is based at least in part on matching the quantity of remaining uses associated with the at least one travel voucher with the specified number of travelers.

13. The computer-implemented method of claim 4 wherein the at least one travel voucher is associated with one or more identifiers that include at least one of a textual identifier and a graphical identifier, and wherein the transmitting of the information representing the selected at least one travel voucher includes providing at least one of the one or more identifiers to the client device of the user.

14. The computer-implemented method of claim 13 wherein the client device of the user is a mobile device associated with the user, and wherein the enabled use of the selected at least one travel voucher includes displaying the at least one identifier, via an application associated with the travel voucher authorization management system executing on the associated mobile device, for presentation to a transportation provider.

15. The computer-implemented method of claim 4 wherein at least some of the first electronic communications and the second electronic communications are provided via a programmatic interface of the travel voucher authorization management system.

16. The computer-implemented method of claim 4 wherein at least some of the first electronic communications and the second electronic communications are provided via one or more user interactions with a graphical user interface of the travel voucher authorization management system.

17. The computer-implemented method of claim 4, further comprising, after the transmitting of the one or more second electronic communications, receiving one or more additional communications indicating a complaint that the enabled use of the selected at least one travel voucher by the user has been prevented.

18. The computer-implemented method of claim 17 further comprising, based at least in part on the indicated complaint, determining to prevent the distinct other user that provided the at least one selected travel voucher from providing future travel vouchers to the travel voucher authorization management system.

19. The computer-implemented method of claim 17 further comprising, based at least in part on the indicated complaint, determining to forward the portion of the one or more monetary usage fees obtained from the user to a party other than the distinct other user that provided the at least one selected travel voucher.

20. The computer-implemented method of claim 17 further comprising, based at least in part on the indicated complaint, selecting a distinct other travel voucher that satisfies at least some of the specified criteria, and transmitting additional information representing the selected distinct other travel voucher to the client device of the user to enable use of the selected distinct other travel voucher by the user.

21. The computer-implemented method of claim 4 wherein the providing of the portion of the obtained monetary usage fees to the distinct other user includes providing the portion of the obtained monetary usage fees to one or more charitable organizations designated by the distinct other user.

22. A non-transitory computer-readable medium having stored contents that, when executed, configure a computing system to:
receive, by the configured computing system, one or more first electronic communications sent over one or more computer networks from a client device of a user, the first electronic communications specifying one or more criteria for a travel voucher requested by the user;
identify, by the configured computing system and from among a plurality of available travel vouchers, a travel voucher associated with multiple voucher characteristics that satisfy at least some of the specified criteria;
transmit, by the configured computing system to the client device of the user via the one or more computer networks, one or more second electronic communications that include information representing the identified travel voucher for use of the identified travel voucher by the user; and
provide, by the configured computing system and to a distinct other user that provided the identified travel voucher, at least a portion of monetary usage fees obtained from the user for use of the identified travel voucher.

23. The non-transitory computer-readable medium of claim 22 wherein the stored contents further configure the computing system to:
receive information regarding the identified travel voucher from the distinct other user;
authenticate the identified travel voucher via a remote travel voucher service provider, the authentication of the identified travel voucher including validation of one or more of the multiple voucher characteristics associated with the identified travel voucher; and
store, based at least in part on the authentication of the identified travel voucher, information representing the identified travel voucher.

24. The non-transitory computer-readable medium of claim 22 wherein each of the plurality of available travel vouchers is associated with one or more identifiers and with voucher characteristics that include one or more of a group that includes a travel route, a travel type, an expiration date, and a quantity of remaining uses.

25. The non-transitory computer-readable medium of claim 22 wherein each of the plurality of available travel vouchers is associated with a respective expiration date, wherein the specified criteria for the requested travel voucher include a specified travel date, and wherein the expiration date of the identified travel voucher is in closer proximity to the specified travel date than the respective expiration dates associated with other respective ones of the plurality of available travel vouchers.

26. The non-transitory computer-readable medium of claim 22 wherein the stored contents further configure the computing system to receive, after the transmitting of the one or more second electronic communications, one or more additional communications indicating that the enabled use of the selected at least one travel voucher by the user has been prevented.

27. The non-transitory computer-readable medium of claim 26 wherein the stored contents further configure the computing system to identify, based at least in part on receiving the one or more additional communications, a distinct second travel voucher that satisfies at least some of the specified criteria, and transmit additional information representing the identified distinct second travel voucher to the client device of the user to enable use of the identified distinct second travel voucher.

28. A system, comprising:
one or more processors; and
at least one memory, the memory including instructions that, upon execution by at least one of the one or more processors, cause the system to:
receive one or more first electronic communications from a client device of a user, the first electronic communications indicating a request that specifies criteria for a desired travel voucher;
select at least one travel voucher from a plurality of available travel vouchers, wherein the selection of the at least one travel voucher is based at least in part on determining that multiple voucher characteristics associated with the at least one travel voucher satisfy at least some of the specified criteria;
transmitting to the client device of the user via the one or more computer networks one or more second electronic communications that include information representing the selected at least one travel voucher in a manner that enables use of the selected at least one travel voucher by the user; and
provide at least a portion of one or more fees obtained from the user for the enabled use of the selected at least one travel voucher to a distinct other user that provided the at least one selected travel voucher.

29. The system of claim 28 wherein the instructions further cause the system to:
receive information regarding the selected at least one travel voucher from the distinct other user;
authenticate the selected at least one travel voucher via a remote travel voucher service provider, the authentication of the selected at least one travel voucher including validation of one or more of the multiple voucher characteristics associated with the selected at least one travel voucher; and
store, based at least in part on the authentication of the selected travel voucher, information representing the selected travel voucher.
